(19) United States
(12) Patent Application Publication
(10) Pub. No.: US 2015/0170113 A1
(43) Pub. Date: Jun. 18, 2015

(54) METHODS, DEVICES, AND COMPUTER READABLE MEDIUMS FOR MICROPAYMENTS

(71) Applicant: Matthew GROTE, Washington, DC (US)

(72) Inventor: Matthew GROTE, Washington, DC (US)

(21) Appl. No.: 14/109,862

(22) Filed: Dec. 17, 2013

(51) Int. Cl. G06Q 20/02; G06Q 20/22

(52) U.S. Cl. CPC G06Q 20/02; G06Q 20/29

(57) ABSTRACT

A method for processing a transaction includes receiving a notification from a content provider of a selection of restricted content by a user, where the restricted content is provided to the user at a purchase price. The method further includes identifying an intermediary provider that linked the restricted content to the content provider. The method further includes deducting, from a payment account associated with the user, an amount equal to or greater than the purchase price. The method further includes transmitting, to the content provider, a first payment amount less than the purchase price. The method also includes transmitting, to the intermediary provider, a second payment amount less than the first payment amount.

### TECHNICAL FIELD

This disclosure relates generally to micropayments and, more particularly, to methods, devices, and computer readable mediums for facilitating micropayments to intermediary parties.

### BACKGROUND

Billions of people browse the Web everyday searching for and downloading content. While some content on the web may be free, other content is associated with a fee for downloading the content. However, instead of paying a content provider with a subscription for access to a plurality of contents, a user may make a micropayment to purchase a particular content from a set of contents. A micropayment system has buyers, sellers, and a broker. When a buyer purchases an item from a seller on a network such as the Internet, the buyer often finds this content through intermediary services such as search engines and social networking platforms. These intermediary services provide a valuable service to buyers and typically earn revenue through advertising to the buyers.

With the number of people browsing the web and willing to pay a small fee for accessing content, pennies can quickly turn into millions of dollars of revenue. Particularly, even small payments by individuals can result in significant income for newspapers, bloggers, and other content creators. However, with the millions of transactions that occur each day, these transactions need to be accounted for. Furthermore, intermediaries that provide linking to a content provider's restricted content are currently not accounted for during collection of micropayments.

For example, FIG. 1 illustrates a conventional micropayment environment 100 involving a buyer 102, seller 104, and broker 105. The seller 104 may provide content to the buyer 102 over network 108. The broker 106 is responsible for collecting the micropayment from the buyer 102, which is forwarded to the seller 104. These transactions and communications are further illustrated in FIG. 2 in which the buyer requests content from the seller (200), the seller sends an invoice to the broker (202) and the content to the buyer (204), and the broker sends and collects an invoice from the buyer (206). However, as illustrated in FIGS. 1 and 2, there is no accounting of an intermediary that provides linkage to a seller's content.

Buyers will not pay for services provided by an intermediary. Particularly, if an intermediary sought to charge buyers for their services, buyers could simply use another free intermediary to find the same content. For example, if Google sought to charge an individual in order to search for a premium newspaper article, the individual could simply choose to use Yahoo! to search or go directly to a newspaper's site. Secondly, the intermediary will not seek to charge for its services in every case. For example, Google will not charge a crawling fee to every site owner on the Web because many sites would not pay, and Google's value to consumers would drop dramatically. Therefore, the intermediary cannot simply charge a flat-rate for their services. Even charging for only premium content has its challenges. Particularly, intermediaries do not know when to charge a service fee for linking to premium content. For example, Facebook does not know when a link to premium content has been posted on a Facebook page.

Sellers also face a challenge in deciding whether or how to pay an intermediary for their services. The seller may not know when an intermediary has provided an introduction with a buyer that may require a payment for the intermediary's service. A malicious actor could pose as an intermediary and charge a fee for a service they never provided. The content provider would be expected to monitor all incoming and outgoing payments. This can be a prohibitively burdensome task when the transactions get into the dozens, hundreds, and thousands in frequency. Further, a seller may find it too burdensome to enter into a contract with every possible intermediary.

Without a solution to these problems, an intermediary may not benefit from micro-payment systems to the extent commensurate with the service they provide.

### SUMMARY

According to some embodiments, a method for processing a transaction includes receiving a notification from a content provider of a selection of restricted content by a user, where the restricted content is provided to the user at a purchase price. The method further includes identifying an intermediary provider that linked the restricted content to the content provider. The method further includes deducting, from a payment account associated with the user, an amount equal to or greater than the purchase price. The method further includes transmitting, to the content provider, a first payment amount less than the purchase price. The method also includes transmitting, to the intermediary provider, a second payment amount less than the first payment amount.

In some embodiments, a method for receiving payments from a payment broker includes transmitting, to the payment broker, a notification of a selection of restricted content by a user, the restricted content provided to the user at a purchase price. The method also includes receiving, from the payment broker, a first payment amount less than the purchase price. The method also includes receiving, from the payment broker, a report identifying an intermediary provider that linked the restricted content to the content provider, where the report indicates a second payment amount less than the first payment amount provided to the intermediary provider.

According to some embodiments a server for processing a transaction includes a processor, a memory coupled to the processor, and a network interface coupled to the processor. The processor is configured to receive a notification from a content provider of a selection of restricted content by a user, where the restricted content is provided to the user at a purchase price. The processor is further configured to identify an intermediary provider that linked the restricted content to the content provider. The processor is further configured to deduct, from a payment account associated with the user, an amount equal to or greater than the purchase price. The processor is further configured to transmit, to the content provider, a first payment amount less than the purchase price. The processor is also configured to transmit, to the intermediary provider, a second payment amount less than the first payment amount.

In some embodiments, a server for receiving payments from a payment broker includes a processor, a memory coupled to the processor, and a network interface coupled to the processor. The processor is configured to transmit, to the payment broker, a notification of a selection of restricted content by a user, where the restricted content is provided to the user at a purchase price. The processor is further configured to receive, from the payment broker, a first payment amount less than the purchase price. The processor is also further configured to receive, from the payment broker, a report identifying an intermediary provider that linked the restricted content to the content provider, where the report indicate a second payment amount less than the first payment amount provided to the intermediary provider.

According to some embodiments, a non-transitory computer readable medium having instructions stored therein, which when executed by a processor in a server for processing a transaction, causes the processor to execute a method that includes receiving a notification from a content provider of a selection of restricted content by a user, where the restricted content is provided to the user at a purchase price. The method further includes identifying an intermediary provider that linked the restricted content to the content provider. The method further includes deducting, from a payment account associated with the user, an amount equal to or greater than the purchase price. The method further includes transmitting, to the content provider, a first payment amount less than the purchase price. The method also includes transmitting, to the intermediary provider, a second payment amount less than the first payment amount.

In some embodiments, a non-transitory computer readable medium having instructions stored therein, which when executed by a processor in a server for receiving payments from a payment broker, causes the processor to execute a method that includes receiving, from the payment broker, a first payment amount less than the purchase price. The method also includes receiving, from the payment broker, a report identifying an intermediary provider that linked the restricted content to the content provider, where the report indicates a second payment amount less than the first payment amount provided to the intermediary provider.

### BRIEF DESCRIPTION OF THE DRAWINGS

The accompanying drawings, which are incorporated herein and form part of the specification, illustrate various embodiments of the present disclosure and, together with the description, further serve to explain the principles of the disclosure and to enable a person skilled in the pertinent art to make and use the embodiments disclosed herein. In the drawings, like reference numbers indicate identical or functionally similar elements.

FIG. 1 is an illustration of a wireless communication system between a buyer, broker, and seller accordance with exemplary embodiments.

FIG. 2 is an illustration of invoice collection in a micropayment system.

FIG. 3 is an illustration of an exemplary wireless communication system.

FIG. 4 is an illustration of an exemplary payment broker server.

FIG. 5 is an illustration of an exemplary invoice collection in a micropayment system that accounts for an intermediary.

FIGS. 6 and 7 are illustrations of exemplary embodiments for identifying an intermediary.

FIGS. 8 and 9 are illustrations of exemplary web pages of an intermediary.

FIG. 10 is an illustration of an exemplary process performed by a payment broker server.

FIG. 11 is an illustration of an exemplary process performed by a content provider server.

FIG. 12 is an illustration of an exemplary mobile device.

FIG. 13 is an illustration of an exemplary server.

FIG. 14 is an illustration of an exemplary computer.

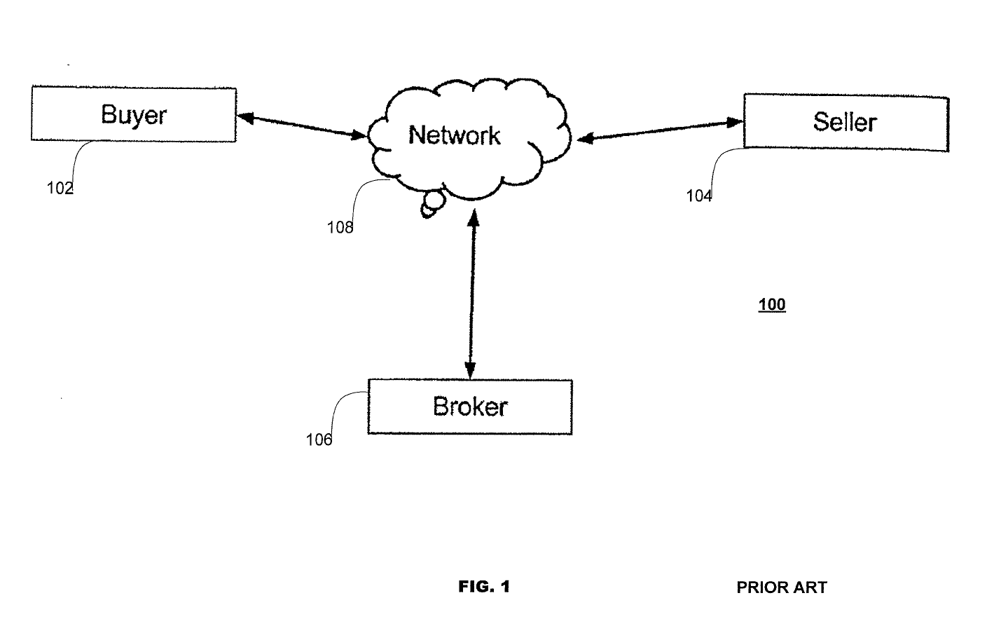

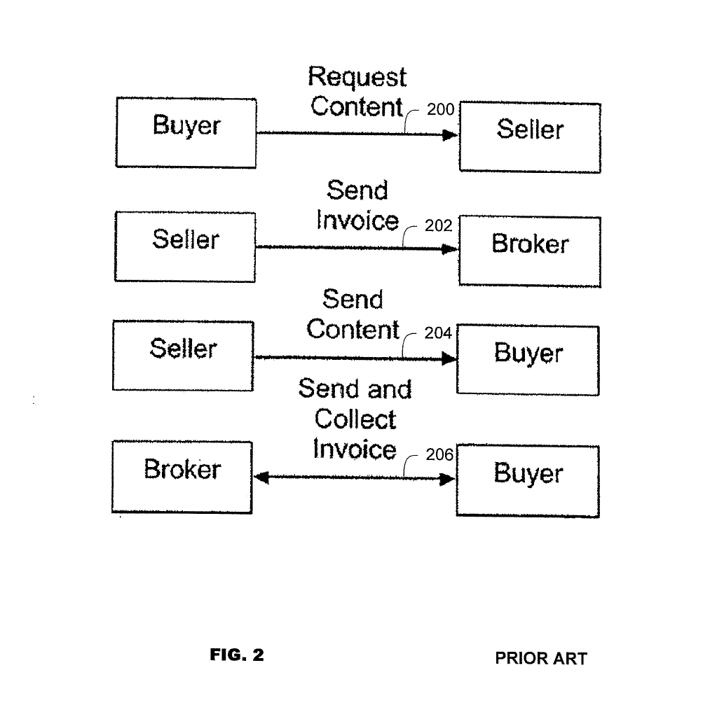

### DETAILED DESCRIPTION

Embodiments are directed to methods, devices, and computer readable mediums for a payment broker to manage the payments between content providers and intermediaries, like search engines and social networks, when the intermediaries serve up links to premium content. The payment broker can designate “intermediary service providers” (in addition to buyers and sellers) in order to manage the rates at which the intermediaries charge for their services and manage payments from the buyers of these services.

In some embodiments, an entity registers with the payment broker as a designated “intermediary.” The payment broker then provides a service to intermediaries by tracking when the intermediaries handle links that point to content requiring a payment (i.e., restricted content, premium content). The content providers (i.e., sellers) are notified of this linking and payments may be automatically made to the intermediaries by the payment broker. By registering with the payment broker, it is ensured that intermediaries receive a payment from content providers when they serve a paid link. In other words, the payment broker ensures a cut of the payment for the premium content for intermediaries. The services provided by the payment broker enable intermediaries to maintain current models while earning revenue from the use of micropayments. For example, users browsing Facebook will notice no difference in the Facebook interface. When users click through to premium content, they may be prompted to make a one-click micropayment. The payment broker tracks the click-through and gives a portion of the micropayment to Facebook. Additionally, users may be provided, on an intermediary's web site, a link to premium content along with a message indicating that if the link is clicked, the user will be automatically charged for the content.

According to some embodiments, the payment broker tracks when a buyer owes a payment to an intermediary service provider. The broker reports this payment in correlation with related payments to ensure transparency. For example, an individual may use Google to find a newspaper article and, in turn, pay ten cents to the newspaper company to read the article. Google may then charge the newspaper company three cents for connecting them with the individual. The payment broker facilitates, for a fee, these payments without any need of a predetermined agreement between Google and the newspaper company. Thus, the intermediary receives 3 cents, the payment broker may keep 2 cents, and the seller receives the remaining five cents. Furthermore, in some embodiments, as part of the monthly invoice, the payment broker provides a description of one or more transactions to both the newspaper company and Google. A note may be included in a user's receipt as well since the user is tied to the transaction.

The payment broker's ability to account for intermediaries provides immense benefits to all parties involved due to the millions of transactions that occur on a daily basis. For example, even at 5 cents per page at 5 pages per day, the revenue is significant. The Washington Post has 10 million readers. That's potentially $821 M dollars per year in revenue, and $91 M in revenue for the payment broker. YouTube has a billion viewers. That's potentially $82B for YouTube and $9B for the payment broker. Even small fractions of these numbers mean large amounts of revenue. By accounting for intermediaries, these revenues will be increased since the intermediaries will provide access to a larger amount of restricted content that requires a purchase fee (i.e., micropayment) to access the content.

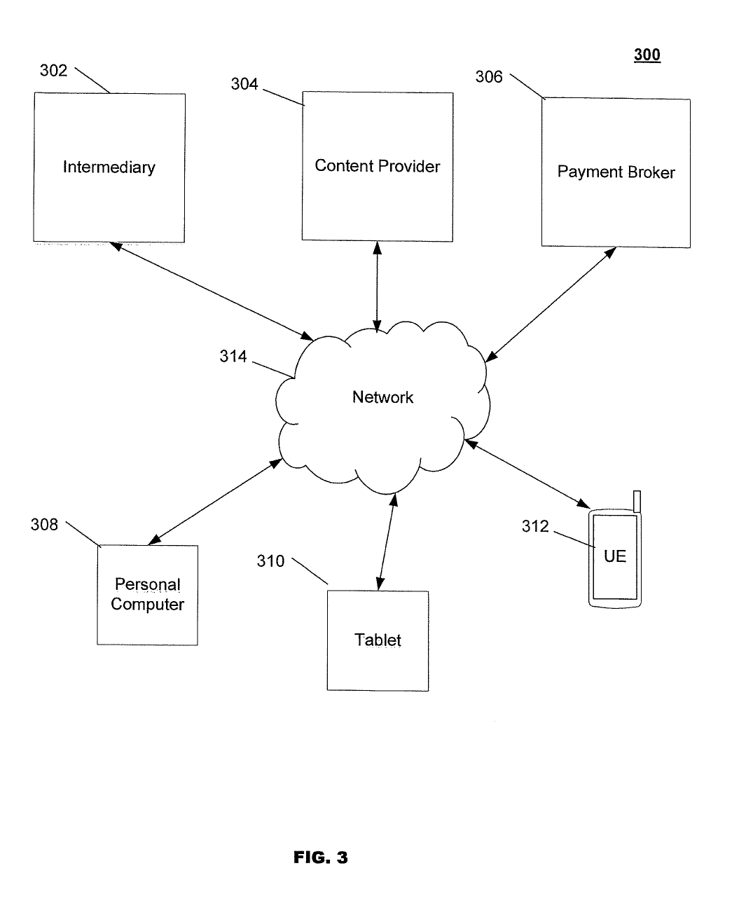

FIG. 3 illustrates an exemplary communication environment. In some embodiments, an intermediary 302, content provider 304, and payment broker 306 are in communication with a network 314. Each of the intermediary 302, content provider 304, and payment broker 306 may include one or more servers that transmits and receives data to and from the network 314. Furthermore, in some embodiments, user devices such as a personal computer 308, tablet 310, or user equipment (UE) 312 communicate with any one of the intermediary 302, content provider 304, and payment broker 306 via the network 314.

The personal computer 308 may be any desktop computing device known to one of ordinary skill in the art such as a Dell XPS or Apple iMac. The tablet 310 may be any tablet computing device known to one of ordinary skill in the art such as an iPad or a Samsung Galaxy Note. The user equipment may be any smartphone known to one of ordinary skill in the art such as an iPhone or Samsung Galaxy S4. The network 314 may be the Internet where the tablet 310 and UE 312 communicates with the network 314 via any wireless communication technology known to one of ordinary skill in the art that enables smartphones and tablet computing devices to connect to the Internet wirelessly. Furthermore, the intermediary 302, content provider 304, payment broker 306, and personal computer 308 may connect to the network 314 via a wired or wireless connection.

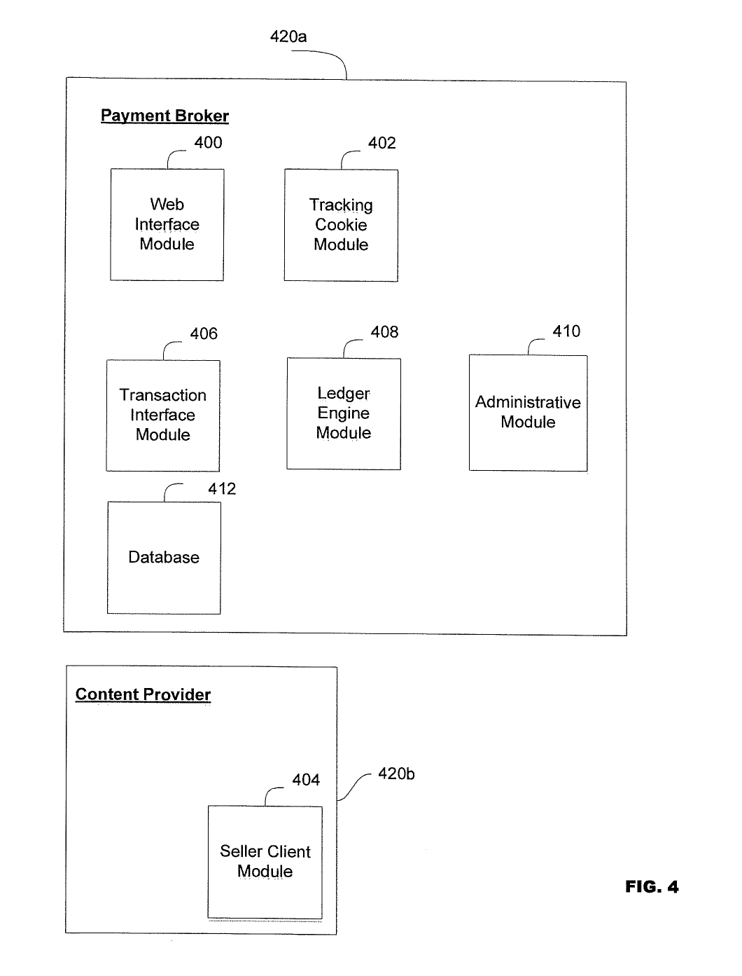

FIG. 4 illustrates an embodiment of a payment broker server 420a and content provider server 420b. The payment broker server 420a may include a web interface module 400, a tracking cookie module 402, a transaction interface module 406, a ledger engine module 408, an administrative module 410, and a database 412. The content provider server 420b may include a seller client module 404. Each module included in the payment broker server 420a may be implemented in software executed by a processor of the payment broker server. Furthermore, each module included in the payment broker server 420a may be implemented as a software/hardware combination. Additionally, each module included in the payment broker server 420a may be implemented by one or more application-specific integrated circuits (ASICS).

The web interface module 400 permits buyers (i.e., users), sellers (i.e., content providers), and intermediaries to set up accounts using an interface to the Internet such as a web browser. The entities can also use the web interface module 400 to track transactions or modify account information. The web interface module 400 interface communicates with the database 412 to store and retrieve transaction and account information.

The tracking cookie module 402 enables the payment broker to establish a cookie in a user's browser. For example, once a user registers with the payment broker, the tracking cookie module 402 establishes a persistent cookie in the user's browser. As the user browses the Web, premium content sites can check with the cookie to ensure that the user is logged into the payment broker and able to pay for premium content.

The seller client module 404, located on the content provider server, facilitates accounting of transactions. For example, once a buyer requests to purchase premium content, the seller's web server client module exchanges credentials with the buyer's tracking cookie, confirms the credentials with the payment broker, and sends invoice information to the seller client module 404 of the payment broker. The seller's web server client module may be “plug and play” module that allows sellers to drop in a payment broker-made module directly within the seller site's html that will facilitate displaying the premium content to payment broker buyers. The payment broker may also provide, instead of the broker provided module, a protocol or API to exchange information about the transaction, such as costs, authentication information, buyer verification, etc.

The transaction interface module 406 communicates with the seller client modules 404 and the database 412 regarding all transactions. The transaction interface module 406 handles the interactions with the seller client module 404 and the tracking cookie module 402. The transaction interface module 406 interacts with the broker database 412 to record transactions. The transaction interface module 406 verifies credentials of buyers, sellers, and intermediaries. The transaction interface module 406 further records purchases and linkage fees into the broker database 412.

The ledger engine module 408 uses the database to tabulate and process monthly invoices to buyers and the payment to sellers. The administrative module 410 allows for summary reports, fraud tacking, transaction adjustments, general accounting, etc.

The database 412 is a central repository for account and transaction information. Each database entry may include one or more the following fields: entity information, log in history, content information, payment history, transaction history, payment history to payee, and cookie.

The entity information field pertains to payers, payees and intermediaries and may specify basic account and payment information and/or current log-ins. The log in history field may specify an entity id, time in, time out, browser information, and/or location information. The content information field may specify an id, creator (payee), creation time, price, and/or active status. The payment history field may specify a payer, date, amount, and/or payment method. The transaction history field may specify a payer, content id, intermediary payee id, time, amount, and/or browser. The payment history to payee field may specify a payee, date, amount, beginning date, end date, and/or payment method. The cookie field may specify a cookie id, certificate id, and/or entity id.

According to some embodiments each user of devices 308, 310, and 312 may access the payment broker 306 via a web browser or an application provided by the payment broker 306 through an application store (i.e., Apple App Store). In some embodiments, the user registers with the payment broker 306 by creating account and providing the payment broker with billing info (i.e., credit card, PayPal, bank account, etc.) to purchase content. As an example, when browsing the web, the user may come across premium content. If the buyer is logged-in to the payment broker, the buyer can click one “Okay” button to view the premium content. This purchase may be verified and tracked by a payment broker cookie and also reported by the seller. In some embodiments, the user can log in to their payment broker account to view their past purchases and monthly invoices. Users can also change their billing info or challenge a payment. Buyers can opt to receive an email invoice notice at the end of each month. The monthly charge may be made automatically.

According to some embodiments, a seller (i.e., content provider 304) may register with the payment broker 306 by creating an account and providing updated payment info (i.e., PayPal, bank account, etc.) to receive monthly payments for their content. In some embodiments, unlike buyers, who are authenticated through the payment broker cookie, sellers use authentication certificates managed by the payment broker to verify their identity and selling status.

In one embodiment, sellers use the seller client module 404 provided by the payment broker to make content available for purchase to users by designating premium content and report transactions to the payment broker. There are several ways a seller may designate premium content. For example, the seller client module 404 could contain or interact with a database on the seller's server. The database would contain data describing pieces of premium content with fields such as identifying number, title, and price. The seller would modify their website to query with the seller client module 404 when loading content to determine if it is premium. If the content is premium, the seller client module 404 communicates with the buyer tracking cookie and with the broker transaction interface module 406 to verify the buyer and notify the broker of the purchase. Once the buyer is verified, the seller provides the premium content. In some embodiments, a determination that the content is premium is made based on a unique identifier in a URL associated with the content. Furthermore, in some embodiments, when the user selects the content, the seller website checks the seller client module 404 to determine if the selected content is premium. In another embodiment, sellers can use their own software to notify the payment broker with specific information when a transaction occurs. These transactions may involve authentication interactions with the payment broker cookie.

In some embodiments, the sellers can manage content by removing any “premium” designations from content or creating new premium content. Sellers can set up tracking mechanisms on their own, use the payment broker seller client module to track transactions, or visit the payment broker website to view transaction information. According to some embodiments, the seller can log in to their payment broker account to view their past transactions and monthly invoices. They can also change their billing info or challenge a payment. Sellers can opt to receive an email invoice notice at the end of each month. The monthly payment will be made automatically.

When clicks to premium content come through search engines or intermediaries, the seller owes a portion of the content payment to the intermediary. If tracking services are enabled, the sellers can track independently whether buyers came from intermediaries. However, they are under no obligation to track intermediary click-throughs. Particularly, in one embodiment, the payment broker notifies sellers on their monthly payment statement where some transactions were charged a “linking fee.” This “linking fee” may be part of the terms-of-service that the seller accepts when registering with the payment broker. The linking fee provides the intermediary a portion of the micropayment paid by the user for purchasing the seller's premium content.

According to some embodiments, intermediaries may register with a payment broker by creating an account with the payment broker and providing payment info (i.e., PayPal, bank account, etc.) to receive monthly payments for linking the seller's premium content. Like sellers, intermediaries may use authentication certificates managed by the payment broker to verify their identity and selling status during transactions. In some embodiments, in order to receive automatic payments for the “linkage fees,” intermediaries can implement certain technologies including functionality requirements for their cookies or internal link tracking and notification to the payment broker.

In some embodiments, intermediaries can log in to their payment broker account to view their past transactions and monthly invoices. Intermediaries can also change their billing info or challenge a payment/non-payment. Given the potential number of intermediary and large seller transactions, the payment broker may need to implement special services to interact with them. For example, viewing thousands of transactions on a website can be cumbersome and exportable spreadsheets may be necessary. As an example, these spreadsheets could contain a list of linkage fee transactions that the broker has on record for the intermediary. If the intermediary sees discrepancies when comparing this list with the list the intermediary has on record, the intermediary can notify the broker and begin a resolution process with the broker.

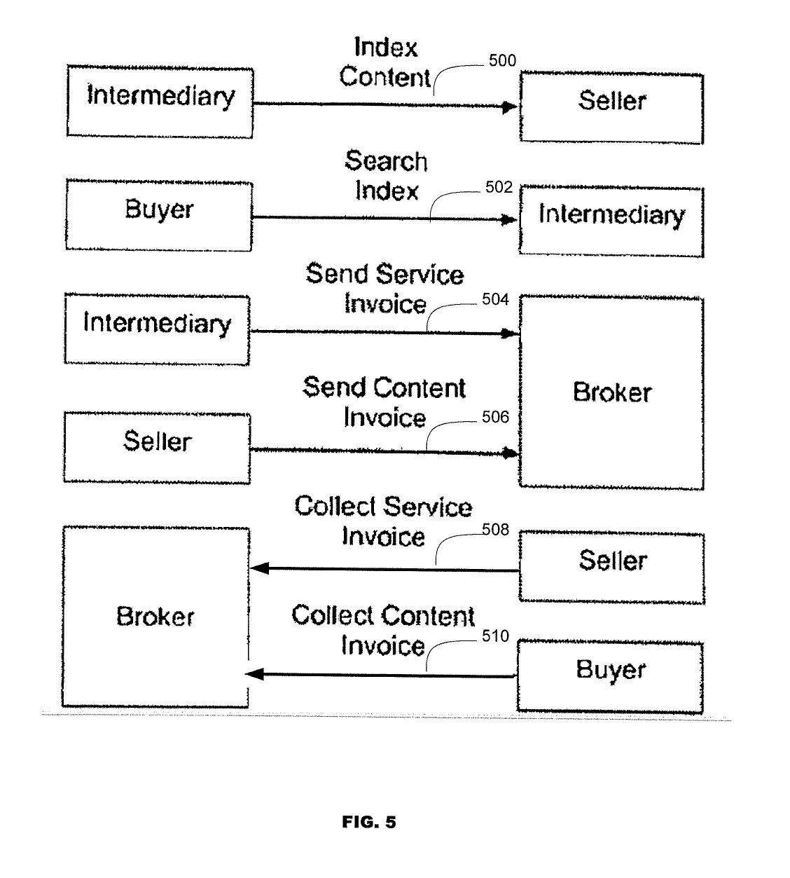

FIG. 5 illustrates an embodiment of the payment broker tracking content purchase and collecting invoices. Upon registration by the intermediary and the seller with the payment broker, the intermediary is able index the seller's content (500). An example of indexing the seller's content includes adding a link to the seller's content on the intermediary's web page. The buyer searches the intermediary's index of the seller's content (502). When the buyer accesses the seller's premium content, the intermediary sends a service invoice to the payment broker (504), and the seller sends a content invoice (506) to the payment broker. The seller collects the service invoice (508) from the payment broker, and the buyer collects the content invoice from the payment broker (510).

The use of the payment broker is illustrated by the following example. Bob (i.e., buyer, user) hears an interesting piece of news about lemmings (i.e., small rodent) on the radio and decides to read more about it online. Bob goes to Google (i.e., intermediary) and searches for lemmings in Google's news search. Multiple headlines come up and one stands out to Bob, which is from the Washington Post. Bob clicks on the link and is directed to the Washington Post (i.e., seller, content provider). The Washington Post let's Bob know that this content requires a fee (i.e., micropayment) to access the content. Bob clicks an “okay” or “purchase” button and continues to read the lemming article. At the end of the month, on his monthly statement from the payment broker, Bob sees that he was charged the given price for the article.

However, prior to Bob searching for the lemming article, the Washington Post had posted the article to their website as a premium article. The Washington Post used the payment broker seller client module to protect the article by designating the article as premium content once the article was posted. Google then crawled the article, “logging in” as a registered intermediary,” and indexed it for all Google users to search. When Bob clicked-through the link on Google, Google's cookie notifies the payment broker cookie of an outgoing link. When the Washington Post received the request from Bob, the seller client module of the Washington Post checked Bob's payment broker cookie for authentication, then notified the payment broker of the transaction. Once the Washington Post checked the payment broker cookie, the cookie matched the Post transaction with the recent click-through from Google and notified the payment broker. Here, the payment broker records the content transaction between Bob and Washington Post, and the linkage fee transaction between the Washington Post and Google.

The payment broker manages service-fee payments, where if an intermediary provides a click-through to premium content, the payment broker ensures that the intermediary is paid a “linking fee” for the service of linking the seller's premium content to an intermediary's web page. According to some embodiments, an intermediary is determined through a tracking cookie. As an example, tracking cookies from intermediaries are used to track click-throughs. Since there may be a relative handful of intermediaries, and since intermediaries may already use tracking cookies, the payment broker can require, as a precondition to registering with the payment broker as an intermediary, a functionality within those tracking cookies to communicate with the payment broker or the payment broker cookie when the payment broker cookie requests this communication. This feature enables the payment broker cookie, when a buyer purchases premium content, to query the intermediaries' tracking cookies to see if the buyer clicked through their site. As an example of cookie tracking, when a buyer visits an intermediary's website, the intermediary's cookie can check for the broker's tracking cookie stored on the buyer's browser. If the broker tracking cookie is active, the intermediary can notify the tracking cookie that the buyer has just visited their site. If the next site visited by the buyer is a premium content page, which is reflected in the tracking cookie, then the broker may determine that the intermediary provided the link and deserves a linkage fee. The payment broker will compare this data on its own server to protect against abuse and fraud. The payment broker may also use spreadsheets, as described above, to track the linkage fees.

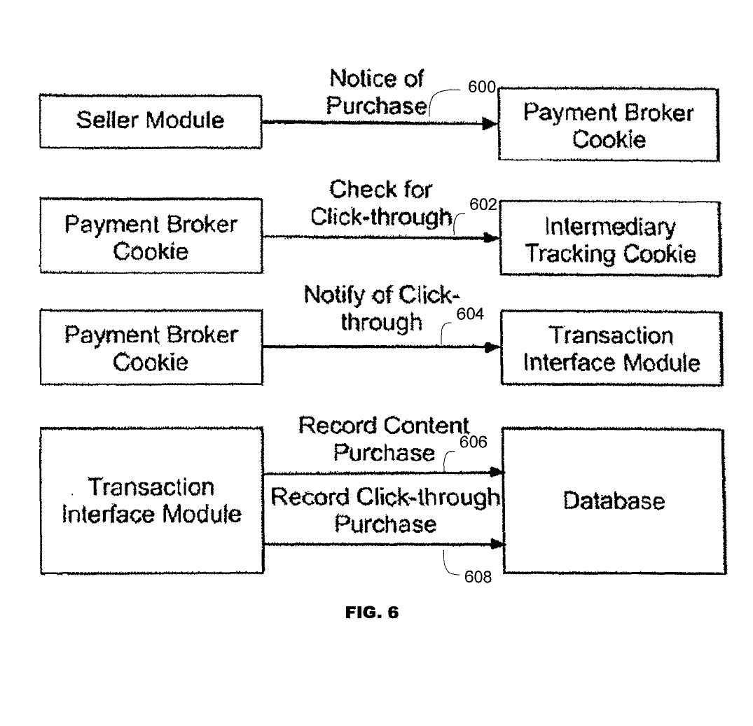

FIG. 6 illustrates an embodiment of using a tracking cookie to track a click-through to identify an intermediary. Particularly, a seller module of a content provider may transmit a notice of purchase (600) to the payment broker cookie. The payment broker cookie checks the intermediary tracking cookie of a click-through (602). If a click-through to the intermediary is found, the payment broker cookie informs the transaction interface module of the payment broker of the click-through (604). Upon receiving the notification of the click-through from the payment broker cookie, the transaction interface module records content purchase (606) and click-through purchase 608 in the database of the payment broker.

In some embodiments, an intermediary is determined by using masked linking to track the click-throughs. Search engines like Google and Yahoo mask indexed URL's in order to track them. For example, when clicking on a Google search link for tomatoes.com, Google first directs the user's browser to a Google tracking server that then bounces the user to tomatoes.com.

An example of masked linking is illustrated as follows. An intermediary's website may show a link to be examplenews.com/story1, but the link will actually direct the user to the intermediary's own server before going to examplenews.com. When the user is directed to the intermediary server, the masked link may read as intermediary.com/function1=examplenews.com/story1. When the intermediary receives this page request, the intermediary server records the user who sent the request, the time of the request, and the destination of the request—all provided in the link URL and the intermediary cookie. The intermediary server then redirects the user's browser to examplenews.com/story1 so quickly that the user does not notice the brief visit to intermediary.com/=examplenews.com/story1. The payment broker can require intermediaries to use such masking technologies to keep track of click-throughs. The broker can require that intermediaries go a step further and check these domains against a list of premium content provider domains provided by the broker. When the intermediary sees a click-through to one of those domains, the intermediary can notify the broker cookie. The payment broker cookie and transaction interface module can then verify whether or not premium content was purchased at that time by that buyer from that domain, and accordingly pass the linking service fee along to the seller.

This tracking ability may be used to notify the payment broker cookie when an intermediary click-through has been made. In one embodiment, the payment broker provides the intermediaries with a list of premium content provider domains. When the intermediary sees a click-through to one of those domains, the intermediary notifies the payment broker cookie. As an example, the broker cookie may be a standard-format file having data created and modified by the broker website and server. The broker cookie can be read by the seller client module and the intermediary's server to know if a buyer is signed-in to the broker's website. The data in the cookie can also contain recent browsing history on intermediaries and seller websites. The cookie can be configured to be edited by an intermediary or seller website, or the intermediaries or sellers can communicate directly with the broker who can edit the cookie accordingly. The payment broker cookie and transaction interface module can then verify whether premium content was purchased at that time by that buyer from that domain, and accordingly report the linking service fee along to the seller.

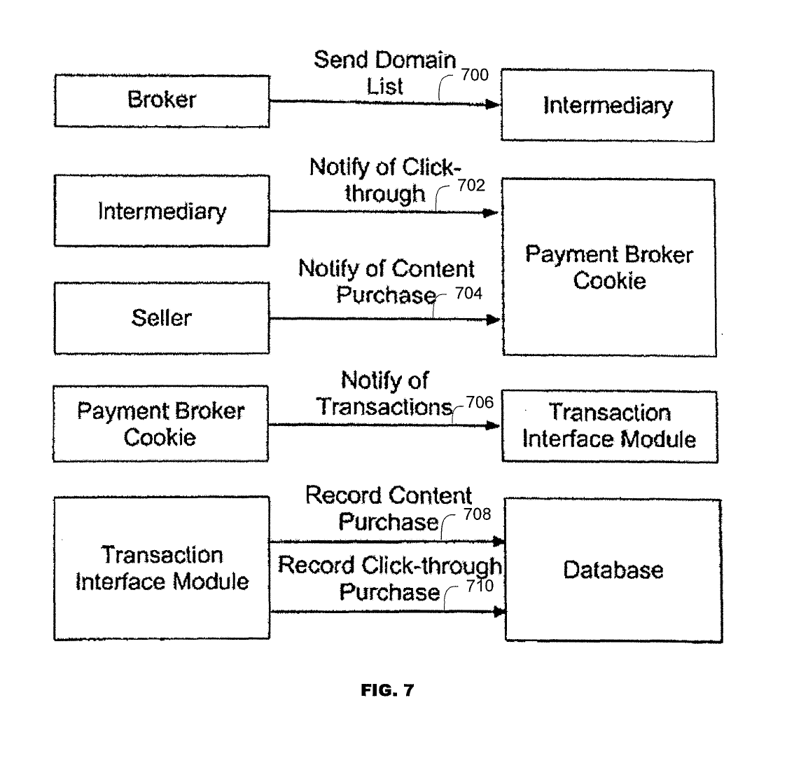

FIG. 7 illustrates an embodiment of using masked linking to track the click-throughs to determine an intermediary. Particularly, the payment broker sends the intermediary a domain list (700). When the intermediary sees a click-through to a seller that is on the domain list, the intermediary notifies the payment broker cookie of the click-through (702). The seller also notifies the payment broker cookie of the purchased content (704). The payment broker cookie sends of notification of transactions to the transaction interface module of the payment broker (706). The transaction interface module records the content purchase (708) and click-through purchase (710) with the database of the payment broker.

According to some embodiments, an intermediary is determined by using a unique URL identifier to track click-throughs. Particularly, URLs for premium content contain a unique identifier. For example, the URL may be specified as http://www.example.com/?cid=123456&tid=9876, where “tid=9876” is the unique payment broker identifier. When an intermediary sees a click-through to a premium content page, the intermediary can notify the payment broker of the transaction. In some embodiments, the seller adds the unique identifier to URL as the premium content is published. The payment broker can compare the intermediary notifications with content purchases to ensure accurate invoices. For example, even if a buyer clicks-through, they may have trouble accessing the page and never view the content; in which case the seller should not be charged a linkage fee. As an example, the payment broker would see the list of premium content provided by the seller over a period of time. The intermediary would also provide to the broker a list of what they believe would have been click-throughs to premium content. These lists could be provided in real-time as the transactions are happening, or they could be provided at the end of the billing period. The payment broker may compare these lists to determine actual premium content received by a user.

One of ordinary skill in the art would understand that the methods tracking a click-through to determine an intermediary are not limited to these embodiments. Particularly, one of ordinary skill in the art may use any known tool track traffic on the Web to determine when linkage fees are due to an intermediary.

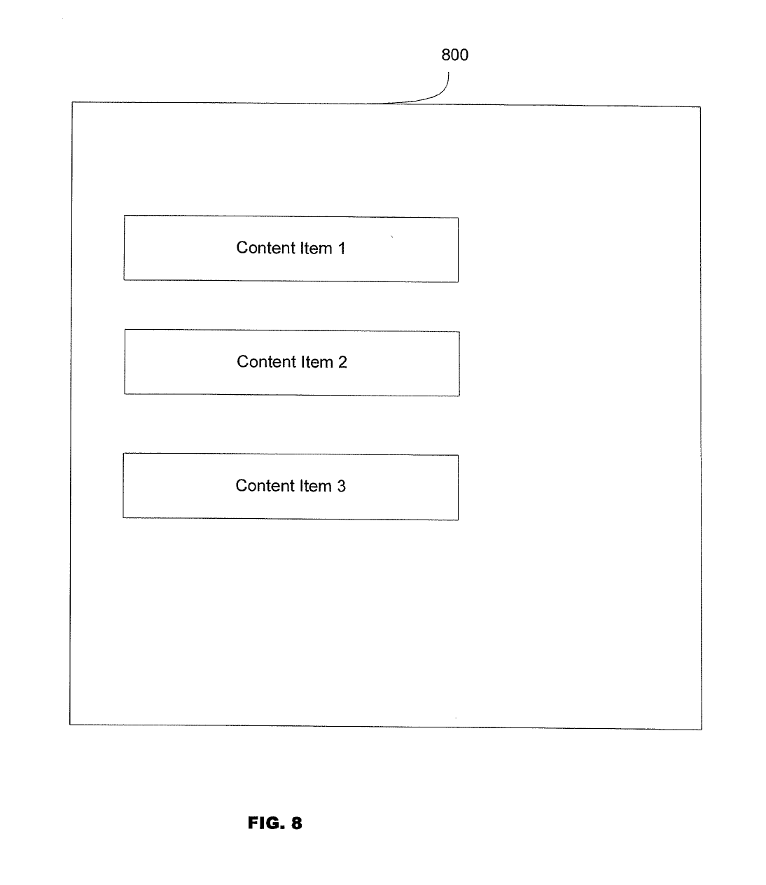

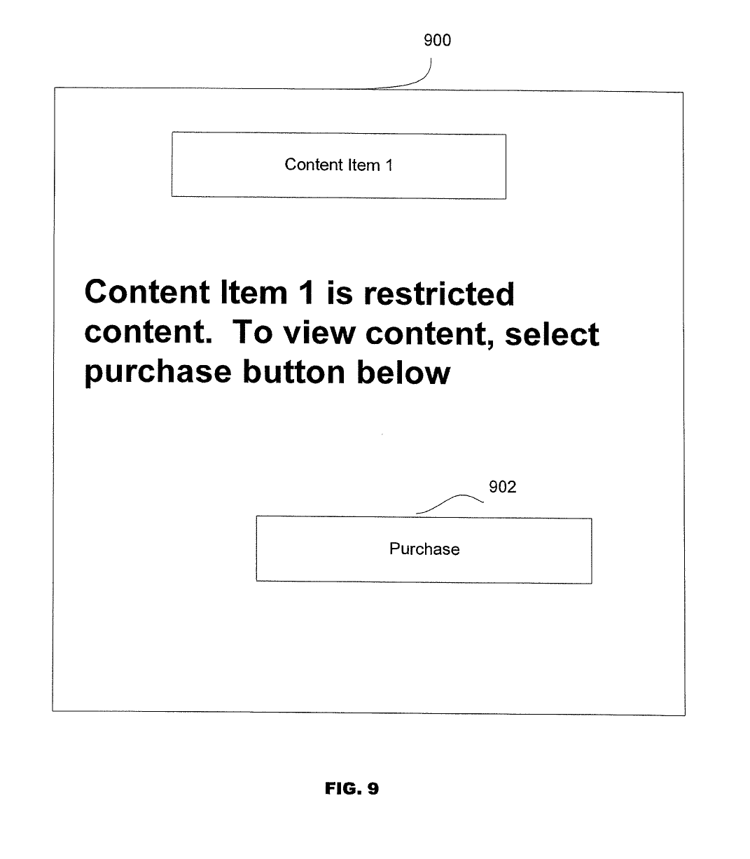

FIG. 8 illustrates an example web page of an intermediary. As illustrated in FIG. 8, the intermediary may provide links to content item 1-3 that having been indexed by intermediary. Content items 1-3 may be a news article, video, sound file, or any other multimedia object known to one of ordinary skill in the art. The content items 1-3 may each belong to the same content provider, or each belonging to a different content provider. FIG. 9 illustrates an example web page 900 upon a user clicking on the link associated with content item 1. If content item 1 is restricted content (e.g., premium content), the web page may display a message that the content item is restricted, and that the user must click a purchase button 902 to view the content time. Upon selection of the purchase button 902, the payment broker cookie may be updated to indicate that the user performed a click-through the intermediary's web page to access the restricted content. The web page 900 may be displayed on either the intermediary's or seller's website. Furthermore, in some embodiments, if a user is not signed into the payment broker's site prior to selecting purchase button 902, the user may be prompted to sign into the payment broker's site. In some embodiments, the user may be permitted to purchase premium content regardless of whether the user is signed into the payment broker's site.

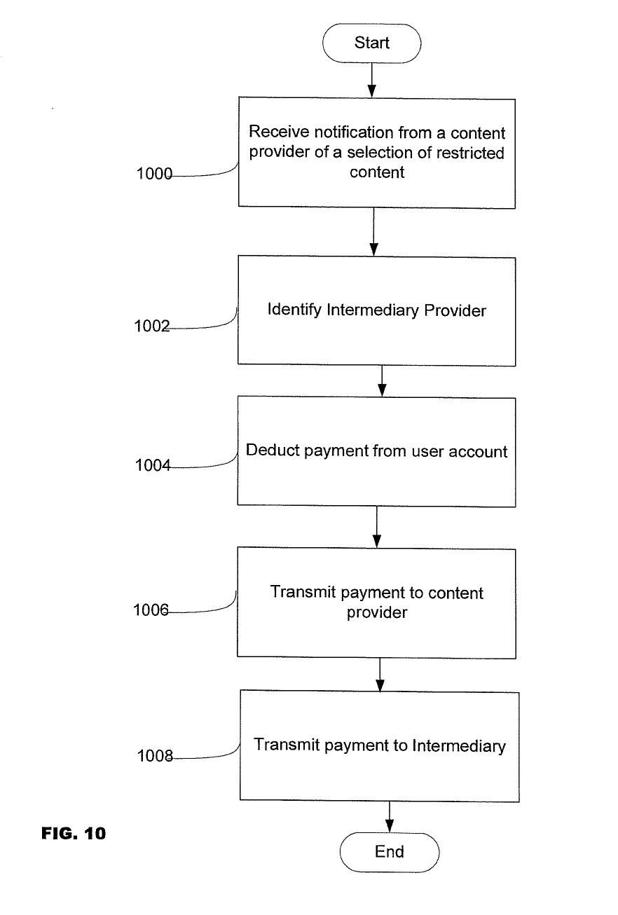

FIG. 10 illustrates an embodiment of a process performed by the payment broker server. The process may generally start at 1000 where the payment broker server receives a notification from a content provider of a selection of restricted content. The process proceeds to 1002 where the payment broker server identifies an intermediary provider that linked the content provider's restricted content. The process proceeds to 1004 where the payment broker deducts a payment from a user account. The process proceeds to step 1006 where the payment broker server transmits a payment to the content provider. The process further proceeds to 1008 where the payment broker server transmits a payment to the intermediary.

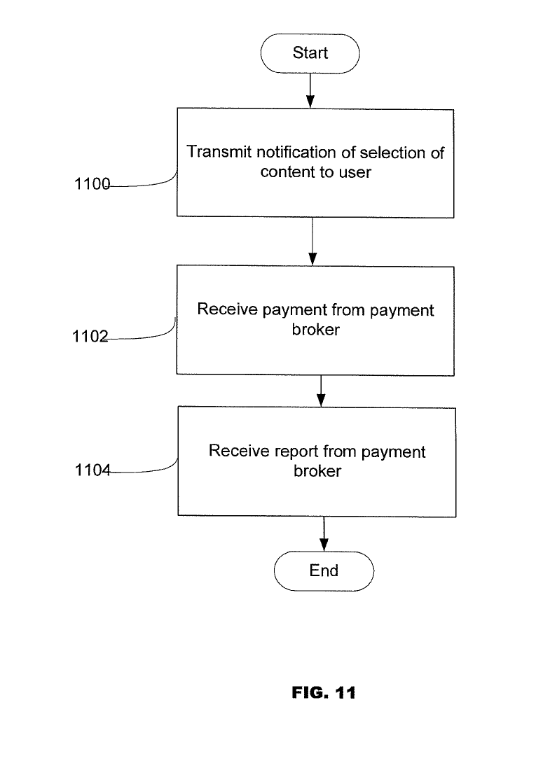

FIG. 11 illustrates an embodiment of a process performed by the content provider server. The process may generally start at 1100 where the content provider server transmits notification of a selection of restricted content to the payment broker. The process proceeds to step 1102 where the content provider server receives a payment from the payment broker. The process further proceeds to 1104 where the content provider server receives a report from the payment broker. This report may include a list of one or more intermediaries that linked the content provider's restricted content that was purchased.

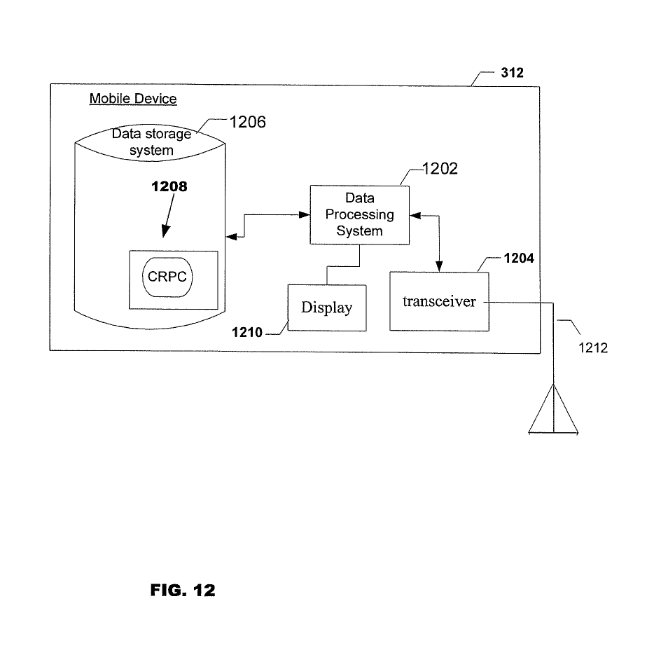

FIG. 12 illustrates a block diagram of an exemplary wireless device, such as device 312 shown in FIG. 3. As shown in FIG. 12, the device 312 may include: a data processing system 1202, which may include one or more microprocessors and/or one or more circuits, such as an application specific integrated circuit (ASIC), field-programmable gate arrays (FPGAs), and the like, a transceiver 1204 connected to an antenna 1212, a data storage system 1206, which may include one or more non-volatile storage devices and/or one or more volatile storage devices (e.g., random access memory (RAM)), and a display 1210, which may display data such as content items or links to content items. According to some embodiments, the data processing system 1202 may comprise a control unit used for selection of transmission parameters.

In embodiments, where data processing system 1202 includes a microprocessor, computer readable program code (CRPC) 1208 may be stored in a computer readable medium, such as, but not limited, to magnetic media (e.g., a hard disk), optical media (e.g., a DVD), memory devices (e.g., random access memory), and the like. In some embodiments, computer readable program code is configured such that when executed by a processor, the code causes the data processing system 1202 to perform processes for receiving and transmitting data. In other embodiments, the device 312 is configured to perform steps described herein without the need for code. That is, for example, data processing system 1202 may consist merely of one or more ASICs. Hence, the features of the embodiments described herein may be implemented in hardware and/or software.

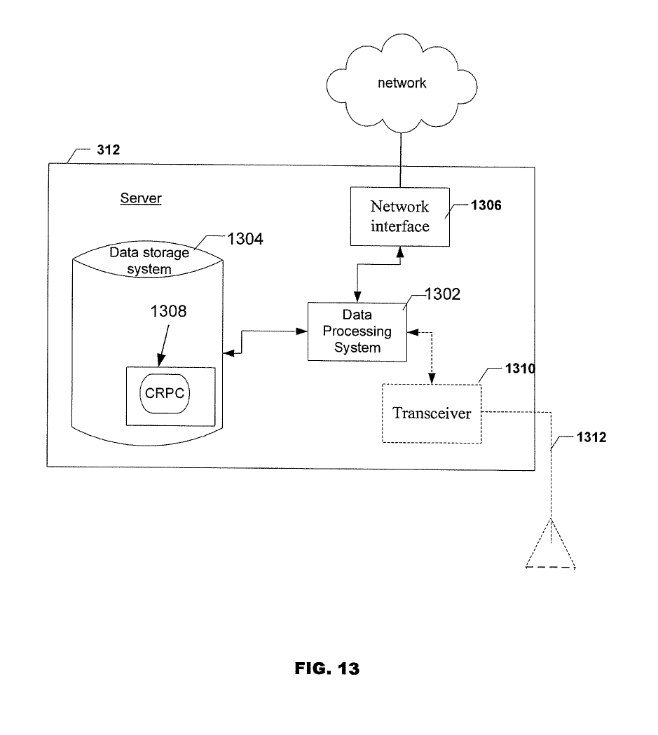

FIG. 13 illustrates a block diagram of an exemplary server, such as intermediary server 302, content provider server 304, or payment broker server 306 shown in FIG. 3. As shown in FIG. 13, the server may include: a data processing system 1302, which may include one or more microprocessors and/or one or more circuits, such as an application specific integrated circuit (ASIC), field-programmable gate arrays (FPGAs), and the like; a network interface 1306, and a data storage system 1304, which may include one or more non-volatile storage devices and/or one or more volatile storage devices (e.g., random access memory (RAM)). According to some embodiments, the data processing system 1302 may comprise a control unit used for selection of transmission parameters. The server may also include a transceiver 1310 connected to antenna 1312 for wireless transmission and reception of data.

In embodiments where data processing system 1302 includes a microprocessor, computer readable program code (CRPC) 1308 may be stored in a computer readable medium, such as, but not limited, to magnetic media (e.g., a hard disk), optical media (e.g., a DVD), memory devices (e.g., random access memory), and the like. In some embodiments, computer readable program code is configured such that when executed by a processor, the code causes the data processing system 1302 to perform steps described above (e.g., steps described above with reference to the flow charts shown in FIGS. 10 and 11). In other embodiments, server is configured to perform steps described herein without the need for code. That is, for example, data processing system 1302 may consist merely of one or more ASICs. Hence, the features of the embodiments described herein may be implemented in hardware and/or software.

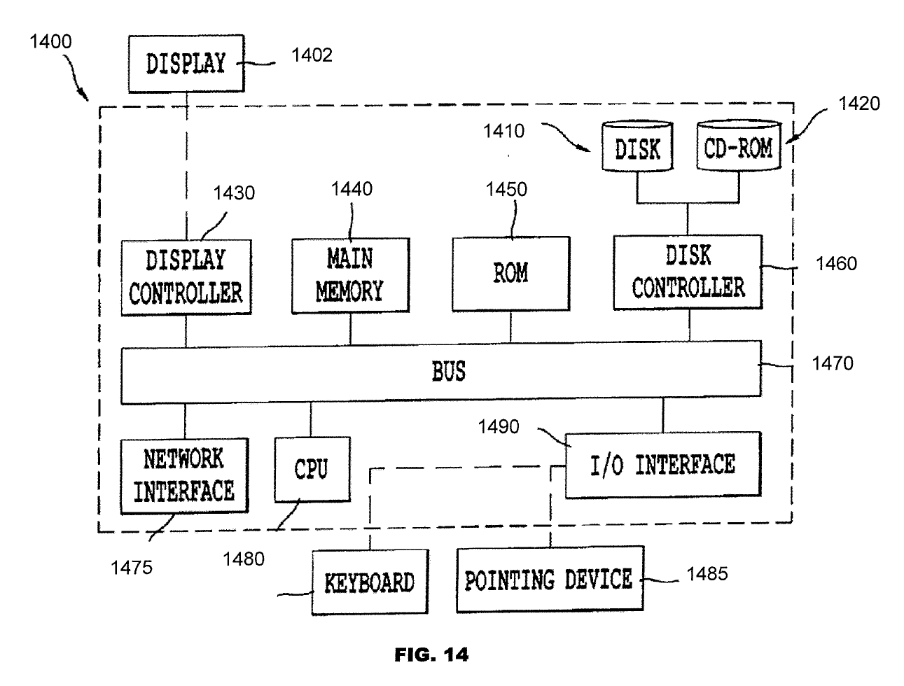

FIG. 14 is a block diagram of a general purpose computer 1400 that may be implemented in personal computer 308 in FIG. 3. In some embodiments, the computer 1400 includes a CPU 1480 which processes data and instructions stored in main memory 1440 and/or ROM 1450. The CPU 1480 may also process information stored on the disk 1410 or CD-ROM 1420. As an example, the CPU 1480 may be an IBM System 4690 from IBM of America employing at least one Xenon processor from Intel of America or an Opteron processor from AMD of America. Thus, instructions corresponding to a process may be stored on any one of the disk 1410, CD-ROM 1420, main memory 1440 or ROM 1450.

In embodiments, the computer 1400 also includes a network interface 1475, such as an Intel Ethernet PRO network interface card from Intel Corporation of America, for interfacing with the network 314 (FIG. 3); a display controller 1430, such as a NVIDIA® GeForce® GTX graphics adaptor from NVIDIA Corporation of America for interfacing with a display 1402, such as a Hewlett Packard HP L2445w LCD monitor. The computer 1400 may also include an I/O interface 1490 for interfacing with a keyboard 1495 and pointing device 1485, such as a roller ball or mouse. According to some embodiments, the disk controller 1460 interconnects disk 1410, such as a hard disk drive or FLASH memory drive, and CD-ROM 1420 or DVD drive with bus 1470, which may be an ISA, EISA, VESA, PCI, or similar for interconnecting all of the components of the computer 1400. A description of the general features and functionality of the display 1402, keyboard 1495 and pointing device 1485, as well as the display controller 1430, disk controller 1460, network interface 1475 and I/O interface 1490 is also omitted for brevity as these features are well known. Of course, other processor and hardware vendors and types are known in the art such as Freescale, ColdFire®, i.MX and ARM processors from Freescale Corporation of America.

The example computer 1400 of FIG. 14 may therefore be a hardware platform of a computing device, such as a PC, and CPU 1480 may for example be an Intel Pentium Processor, or any other desired processor known in the art. The computer-readable instructions stored on any one of the main memory 1440, ROM 1450, disk 1410 or CD-ROM 1420 may be provided as a utility application, background daemon, or component of an operating system, or combination thereof, executing in conjunction with CPU 1480 and an operating system such as Microsoft Windows® VISTA, UNIX®, Solaris®, LINUX®, Apple® MAC OS® and other systems known to those skilled in the art. Main memory 1440 and/or ROM 1450 support registries and the like features of the computer 1400. As such, main memory 1440 may be a random access memory (RAM), FLASH memory, EEPROM memory, or the like, while ROM 1450 is Read Only Memory, such as PROMs. Further descriptions of the main memory 1440 and the ROM 1450 are omitted for brevity as such memory is well known.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that, although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or non-transitory computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the following examples of embodiments and their equivalents, and shall not be restricted or limited by the foregoing detailed description.

1. A method for processing a transaction, the method comprising:
receiving a notification from a content provider of a selection of restricted content by a user, the restricted content provided to the user at a purchase price;
identifying an intermediary provider that linked the restricted content to the content provider;
deducting, from a payment account associated with the user, an amount equal to or greater than the purchase price;
transmitting, to the content provider, a first payment amount less than the purchase price; and
transmitting, to the intermediary provider, a second payment amount less than the first payment amount.

2. The method according to claim 1, wherein the purchase price is a discounted price that is less than a general market subscription price offered to general market subscribers of the content provider.

3. The method according to claim 1, wherein the intermediary provider is identified via a file that includes a browsing history of the user.

4. The method according to claim 1, wherein the intermediary provider is identified via a uniform resource locator that includes a unique identifier associated with the restricted content.

5. A method for receiving payments from a payment broker, the method comprising:
transmitting, to the payment broker, a notification of a selection of restricted content by a user, the restricted content provided to the user at a purchase price;
receiving, from the payment broker, a first payment amount less than the purchase price; and
receiving, from the payment broker, a report identifying an intermediary provider that linked the restricted content to the content provider, the report indicating a second payment amount less than the first payment amount provided to the intermediary provider.

6. The method according to claim 5, wherein the purchase price is a discounted price that is less than a general market subscription price offered to general market subscribers of the content provider.

7. The method according to claim 5, wherein the intermediary provider is identified via a file that includes a browsing history of the user.

8. The method according to claim 1, wherein the intermediary provider is identified via a uniform resource locator that includes a unique identifier associated with the restricted content.

9. A server for processing a transaction, the server comprising:
a processor;
a memory coupled to the processor;
a network interface coupled to the processor;
wherein the processor is configured to:
receive a notification from a content provider of a selection of restricted content by a user, the restricted content provided to the user at a purchase price,
identify an intermediary provider that linked the restricted content to the content provider,
deduct, from a payment account associated with the user, an amount equal to or greater than the purchase price,
transmit, to the content provider, a first payment amount less than the purchase price, and
transmit, to the intermediary provider, a second payment amount less than the first payment amount.

10. The server according to claim 9, wherein the purchase price is a discounted price that is less than a general market subscription price offered to general market subscribers of the content provider.

11. The server according to claim 9, wherein the intermediary provider is identified via a file that includes a browsing history of the user.

12. The server according to claim 9, wherein the intermediary provider is identified via a uniform resource locator that includes a unique identifier associated with the restricted content.

13. A server for receiving payments from a payment broker, the server comprising:
a processor;
a memory coupled to the processor;
a network interface coupled to the processor;
wherein the processor is configured to:
transmit, to the payment broker, a notification of a selection of restricted content by a user, the restricted content provided to the user at a purchase price,
receive, from the payment broker, a first payment amount less than the purchase price, and
receive, from the payment broker, a report identifying an intermediary provider that linked the restricted content to the content provider, the report indicating a second payment amount less than the first payment amount provided to the intermediary provider.

14. The server according to claim 13, wherein the purchase price is a discounted price that is less than a general market subscription price offered to general market subscribers of the content provider.

15. The server according to claim 13, wherein the intermediary provider is identified via a file that includes a browsing history of the user.

16. The server according to claim 13, wherein the intermediary provider is identified via a uniform resource locator that includes a unique identifier associated with the restricted content.

17. A non-transitory computer readable medium having instructions stored therein, which when executed by a processor in a server for processing a transaction, causes the processor to execute a method comprising:
receiving a notification from a content provider of a selection of restricted content by a user, the restricted content provided to the user at a purchase price;
identifying an intermediary provider that linked the restricted content to the content provider;
deducting, from a payment account associated with the user, an amount equal to or greater than the purchase price;
transmitting, to the content provider, a first payment amount less than the purchase price; and
transmitting, to the intermediary provider, a second payment amount less than the first payment amount.

18. The non-transitory computer readable medium according to claim 17, wherein the purchase price is a discounted price that is less than a general market subscription price offered to general market subscribers of the content provider.

19. The non-transitory computer readable medium according to claim 17, wherein the intermediary provider is identified via a file that includes a browsing history of the user.

20. The non-transitory computer readable medium according to claim 17, wherein the intermediary provider is identified via a uniform resource locator that includes a unique identifier associated with the restricted content.

21. A non-transitory computer readable medium having instructions stored therein, which when executed by a processor in a server for receiving payments from a payment broker, causes the processor to execute a method comprising:
transmitting, to the payment broker, a notification of a selection of restricted content by a user, the restricted content provided to the user at a purchase price;
receiving, from the payment broker, a first payment amount less than the purchase price; and
receiving, from the payment broker, a report identifying an intermediary provider that linked the restricted content to the content provider, the report indicating a second payment amount less than the first payment amount provided to the intermediary provider.

22. The method according to claim 21, wherein the purchase price is a discounted price that is less than a general market subscription price offered to general market subscribers of the content provider.

23. The method according to claim 21, wherein the intermediary provider is identified via a file that includes a browsing history of the user.

24. The method according to claim 21, wherein the intermediary provider is identified via a uniform resource locator that includes a unique identifier associated with the restricted content.
